(19) United States
(12) Patent Application Publication
(10) Pub. No.: US 2024/0028865 A1
(43) Pub. Date: Jan. 25, 2024

(54) SYSTEM AND METHOD FOR CAUSAL ANALYSIS OF BIOSYSTEMS ON CHIPS

(71) Applicant: Dell Products L.P., Round Rock, TX (US)

(72) Inventors: OFIR EZRIELEV, Be'er Sheva (IL); AMIHAI SAVIR, Newton, MA (US); Avitan Gefen, Lehavim (IL); Nicole Reineke, Northborough, MA (US)

(21) Appl. No.: 17/872,990

(22) Filed: Jul. 25, 2022

(51) Int. Cl. G06N 3/00

(52) U.S. Cl. CPC G06N 3/002

(57) ABSTRACT

Methods and systems for operating biosystem on a chip are disclosed. To operate biosystem on a chip based systems, causal mechanisms may be identified based on previous operations performed by the biosystem chip based systems. The causal mechanisms may be used to develop new operation plans, refine existing operation plans, and/or develop new biosystem on a chip architecture. The causal mechanism may be derived from a causal graph that includes nodes representing unknown causal mechanisms. Data regarding previous operations in combination with the causal graph may be used to learn the unknown causal mechanisms.

### FIELD

Embodiments disclosed herein relate generally to causal analysis. More particularly, embodiments disclosed herein relate to systems and methods for causal analysis of a biosystem on a chip.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a block diagram illustrating a biosystem on a chip deployment in accordance with an embodiment.

FIG. 2A shows a block diagram illustrating a first data flow in accordance with an embodiment.

FIG. 2B show block diagrams illustrating a first data structure in accordance with an embodiment.

FIG. 2C shows a block diagram illustrating a second data flow in accordance with an embodiment.

FIG. 2D show block diagrams illustrating a second data structure in accordance with an embodiment.

FIG. 2E show block diagrams illustrating a third data flow in accordance with an embodiment.

FIG. 3A shows a flow diagram illustrating a method of storing and using data in accordance with an embodiment.

FIG. 3B shows a flow diagram illustrating a method of servicing information requests in accordance with an embodiment.

FIG. 3C shows a flow diagram illustrating a method of operating a biosystem on a chip deployment in accordance with an embodiment.

FIGS. 4A-4C show diagrams illustrating a system, operations performed thereby, and data structures used by the system over time in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for managing operation of systems on chips (BoC). BoC systems may include complex microfluidic devices. To ascertain how best to use a BoC to produce a desired product, an operation plan for producing the desired product may be initially generated and used to operate the BoC.

During the operation of the BoC, both control data used to orchestrate operation of the BoC (e.g., used to drive actuators, pumps, and/or other active components) and sensor data reflecting conditions within and near the BoC may be recorded.

The architecture of the BoC and recorded operation data (both control and sensor data) may then be used to establish a causal graph through which causal mechanisms for the BoC may be obtained. The causal mechanisms may provide insight into how changes in the operation of the BoC and/or changes in the BoC architecture may impact subsequently performed operations. The causal mechanisms may be used to refine the operation plans so that BoC based systems are more likely to provide desired products and/or otherwise operate in desired manners.

By doing so, embodiments disclosed herein may provide a system that is more likely to operate in desired manners and produce desired products. For example, by identifying causal mechanisms, operating plans for BoCs may be refined in a manner that reduces risk of failures of the BoCs during their operation.

In an embodiment, a method for managing operation of a biosystem on a chip (BoC) deployment is provided. The method may include obtaining: input operation data for a previously performed operation with the BoC deployment, and a graph representation based on an architecture of a BoC of the BoC deployment; obtaining an approximation function based on the input operation data; obtaining a causal graph based on the graph representation, the causal graph comprising a first portion of nodes associated with the approximation function, a second portion of nodes corresponding to nodes of the graph representation, and edges between the second portion of the nodes representing causal mechanisms for components of the architecture of the BoC; identifying the causal mechanisms for the components of the architecture of the BoC using the approximation function and operation data from the previously performed operation with the BoC deployment, the operation data comprising sensor data indicating characteristics of the components of the architecture of the BoC during the previously performed operation; obtaining a new process plan for the BoC using the identified causal mechanisms, the new process plan being different from a previous process plan used during the previously performed operation; and performing a new operation with the BoC deployment based on the new process plan to generate a desired output material.

Obtaining the causal graph may using the graph representation as a template, the template comprising first nodes corresponding to architectural features of the BoC with edges between the first nodes indicating fluid connectivity between the architectural features; defining edges of the template to represent the causal mechanisms; and adding the first portion of the nodes to the template to obtain the causal graph.

The features of the architecture may include a chamber positioned in a body of the BoC; and a channel positioned with the chamber and adapted to place the chamber in fluid communication with another feature of the architecture.

The identified causal mechanisms may indicate causal relationships that are likely to be true during performance of the new operation of the BoC deployment.

A causal relationship of the causal relationships may indicate a functional relationship between a fluid pressure in the chamber and a fluid flow rate through the channel.

The input operation data may include control data used to orchestrate performance of the previously performed operation with the BoC deployment, the control data defining actions performed by active components of the BoC deployment during the previously performed operation.

The graph representation may include architectural element nodes with edges that indicate fluid connectivity between elements of the architecture of the BoC corresponding to the architectural element nodes, and each of the architectural elements nodes being associated with database entries of a database.

The database entries associated with each of the architectural element nodes may include related sensor measurements, the architectural elements nodes facilitating identification of all related sensor measurements during the previously performed operation. The database may be an unstructured database.

The BoC deployment may take, as input, an input material and through performance of the new operation generate the desired output material.

A non-transitory media may include instructions that when executed by a processor cause the computer-implemented method to be performed.

A data processing system may include the non-transitory media and a processor, and may perform the computer-implemented method when the computer instructions are executed by the processor.

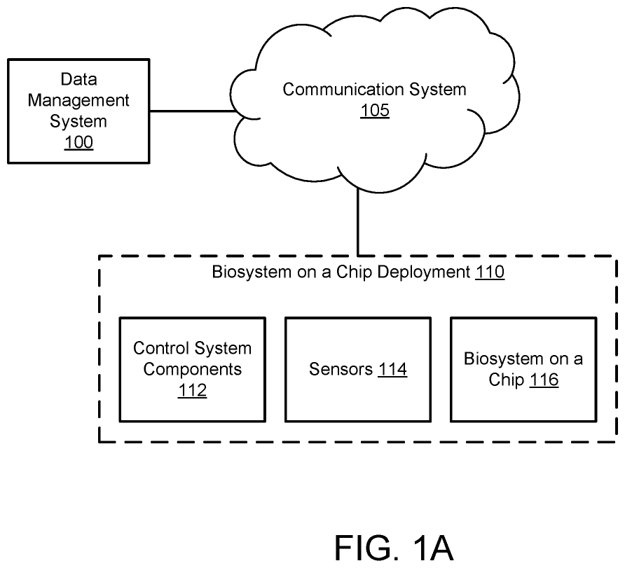

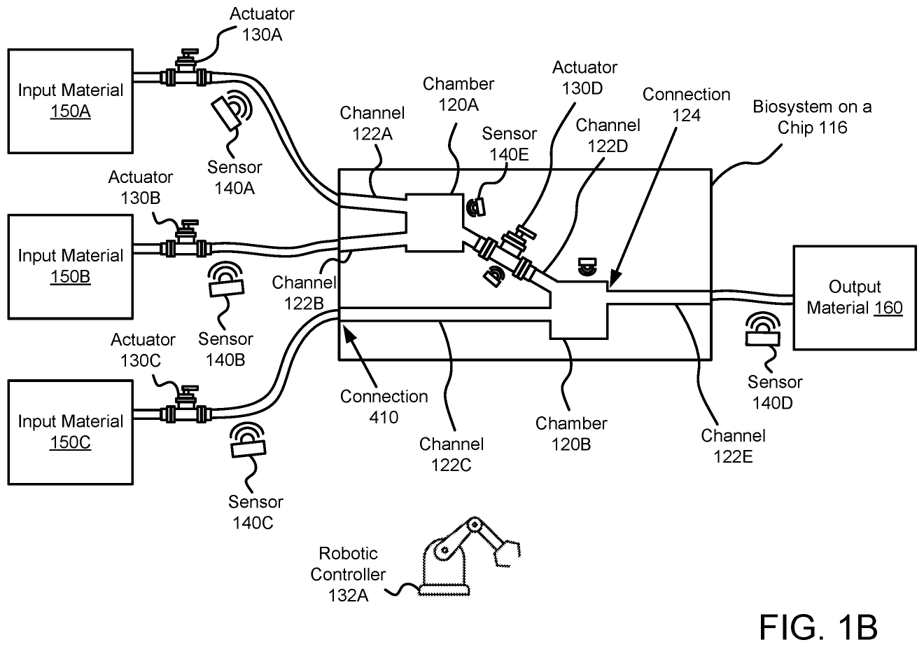

Turning to FIG. 1A, a block diagram illustrating a system in accordance with an embodiment is shown. The system shown in FIG. 1A may provide computer-implemented services that may utilize operation data one or more Biosystems on a Chip (BoC) as part of the provided computer-implemented services.

A BoC may be a physical device that performs one or more processes to emulate and/or duplicate processes that biological systems may perform. For example, biological systems may perform various types or processes through which input materials (e.g., proteins, chemicals, etc.) may be transformed into output materials. These processes may be performed, for example, at a cellular level, at a tissue level, at an organ level, and/or at other levels of biological systems.

To operate a BoC, BoC deployment 110 may include BoC 116, control system components 112, sensors 114, and/or other components. Each of these components is discussed below.

Generally, BoC 116 may be implemented with a physical structure that includes channels, chambers, and/or other fluidic components usable to channel, store, mix, and/or otherwise direct interactions between various fluids (in which various materials may be entrained). For example, BoC 116 may be implemented with a micro-fluidic device or other types of devices that may facilitate input of various fluids, direct interaction of the input fluids and/or manage the fluids as they traverse BoC 116, and output a product or other material (e.g., such as a new material generated through flow of the input material(s) through BoC 116).

To manage the fluids, direction of the fluids, conditions to which the fluids area exposed, and/or otherwise manage BoC 116, BoC deployment 110 may include control system components 112. Control system components may include any number of devices (e.g., valves, heaters, chillers, pumps, etc.) for controlling the flow of fluids through BoC 116, the environment (e.g., temperature, pressure, light exposure, etc.) to which the fluids are exposed in BoC 116, and/or otherwise managing processes performed with BoC 116.

To identify the processes occurring within BoC 116, BoC deployment 110 may include any number of sensors 114. Sensors 114 may be positioned with control systems components 112 and/or BoC 116, and may be adapted to monitor the processes being performed with BoC 116. For example, sensors 114 may include any number of flow rate sensors, temperature sensors, pressure sensors, and/or other types of sensors. Sensors 114 may be implemented using any type of hardware devices usable to measure any number and types of characteristics of the processes performed with BoC 116.

While illustrated in FIG. 1A as being separate components, any of the components of BoC deployment 110 may be integrated (entirely or partially) with each other. Refer to FIG. 1B for additional details regarding BoC deployment 110.

As part of its operation, BoC deployment 110 may generate operation data. The operation data may reflect, for example, the operation of control system components 112 and sensors 114. For example, information regarding operation of a pump used to pump material into BoC 116 over time, pressures within portions of BoC 116, temperatures within the portions of BoC 116, and/or other types of information may be generated. This information may be usable, for example, to guide subsequent use of BoC deployment 110, use of other BoCs (not shown) or BoC deployments (not shown), and/or for other purposes.

For example, a downstream consumer (e.g., a researcher using an application) that may wish to implement a particular process may desire to review operation data from BoC systems to ascertain whether the process may be implemented using the BoC systems. Similarly, due to the complexity of operating BoC based systems, a downstream consumer may wish to ascertain whether a similar process has been performed in the past using a BoC. If the operation data for the previously performed processes is available, then the downstream consumer may use the operation data (rather than performing a new process with a BoC) as a substitute for a new process or to guide performance of a new process using a BoC.

In general, embodiments disclosed herein may provide methods, systems, and/or devices for (i) managing storage and use of operation data for BoC based systems and (ii) facilitating performance of new processes using BoC based systems and/or performing root cause analysis with respect to previously performed operations. To this functionality, the system of FIG. 1A may include data management system 100. Data management system 100 may manage storage of BoC based system operation data, facilitate comparison between different BoC systems (which may use different BoCs having different architectures), facilitate use of the stored operation data, and establish causal relationships usable to design new processes and/or better understand previously performed processes so that new processes may result in more desirable operation of BoC based processes.

To manage storage of operation data and facilitate exploration, data management system 100 may (i) store operation data for BoC systems in a database, which may be unstructured, (ii) obtain graph representations for the BoC systems, (iii) link the graph representations (or portions thereof) to portions of the database in which operation data for a corresponding BoC based system is stored, and/or (iv) facilitate comparison between different BoC based systems through generation and use of metagraphs based on the graph representations of the BoCs. By doing so, embodiments disclosed herein may provide a system capable of managing large amounts of operation data from BoC based systems in a manner that better facilitates subsequent use of the BoC based system operation data (e.g., when compared to only storing the operation data in a database).

To establish causal relationships for BoC deployment 110, data management system 100 may (i) generate causal graphs based on graph representations of BoC based systems, (ii) establish function approximations of previous stimulus to BoC systems (e.g., which may be based on control data used to manage operation of BoC systems during past operations), and (iii) use the causal graph, function approximations, and/or operation data (e.g., sensor measurements) during previous operations to establish causal mechanisms for the manner in which a BoC operates. By doing so, the system of FIG. 1A may facilitate process improvement in BoC based systems. For example, by identifying causal mechanisms that explain past operation of a BoC, the causal mechanisms may be used to establish new process plans (e.g., steps and/or other information for performing a processes using a BoC) that are more likely to result in successful outcomes (e.g., generation of desired output materials such as certain types of proteins or other biological materials using various input materials)

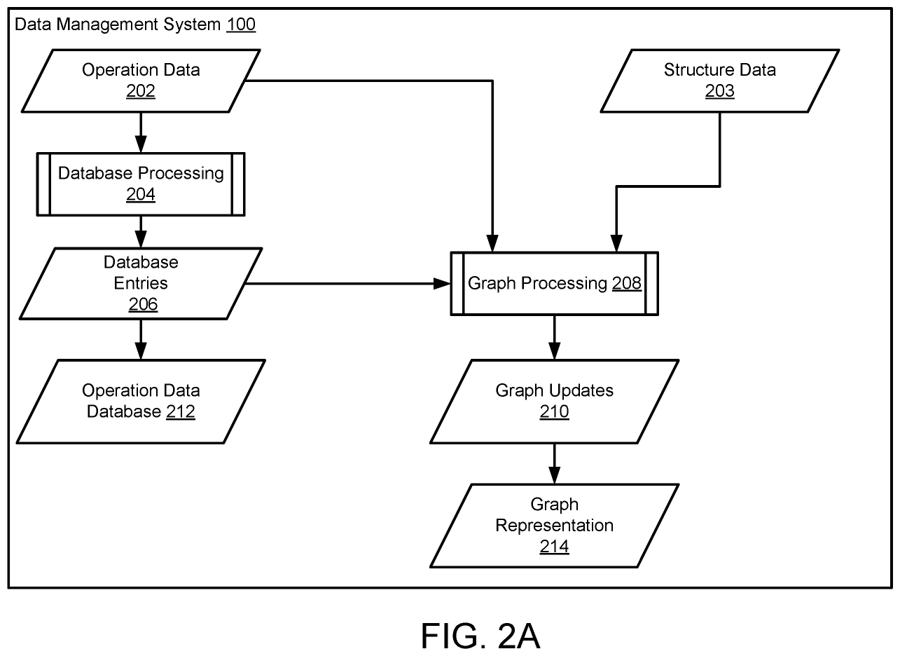

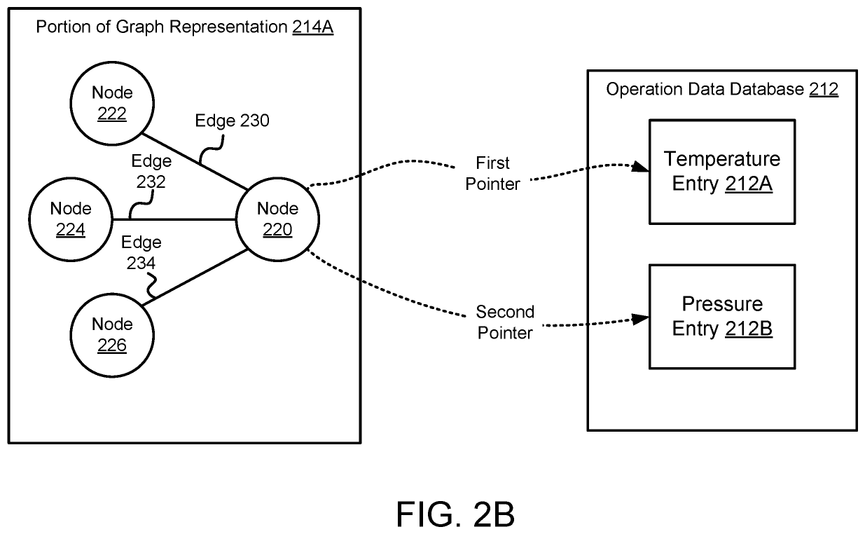

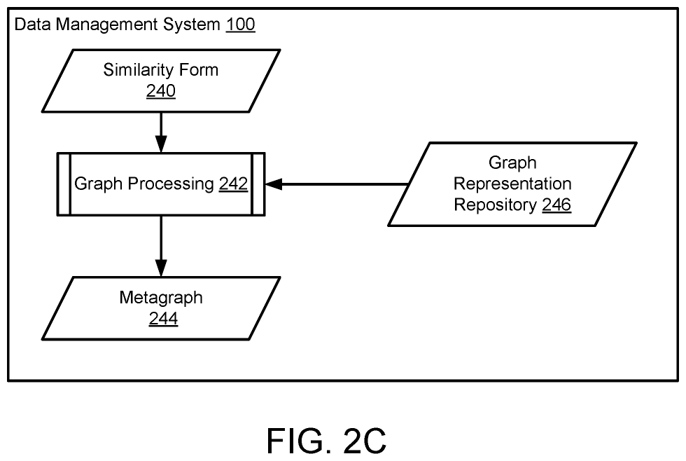

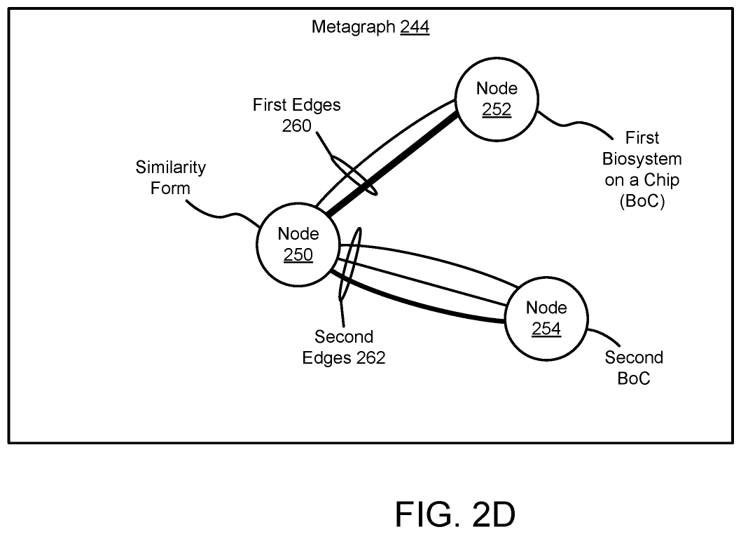

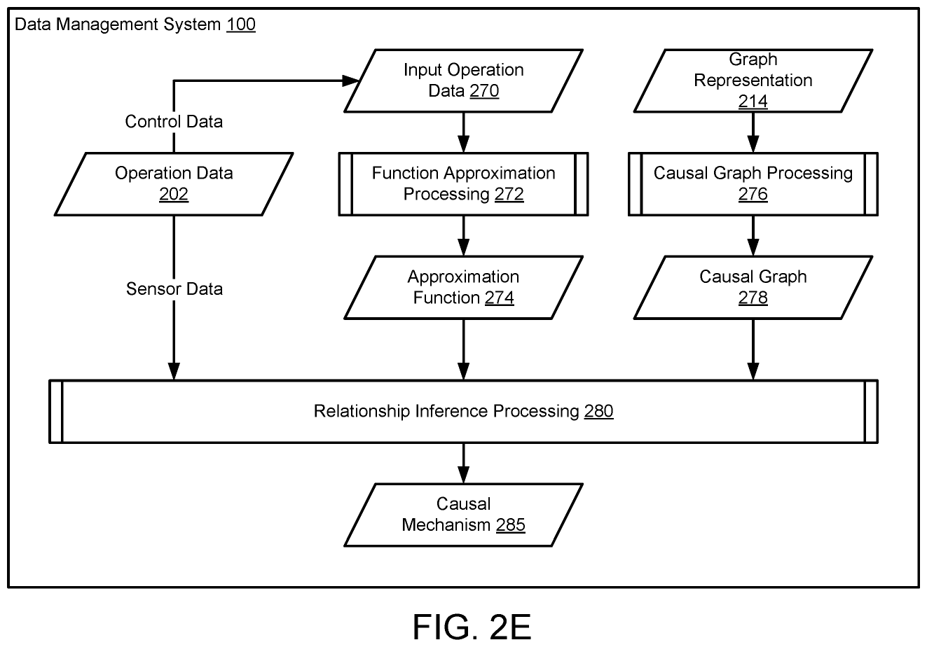

Refer to FIGS. 2A-2E for additional details regarding the functionality of data management system 100.

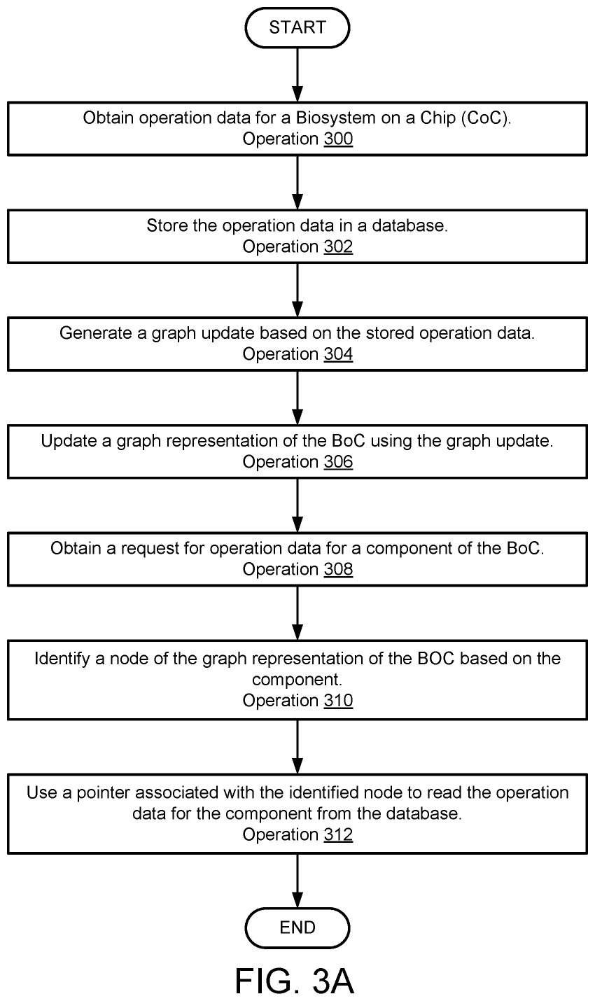

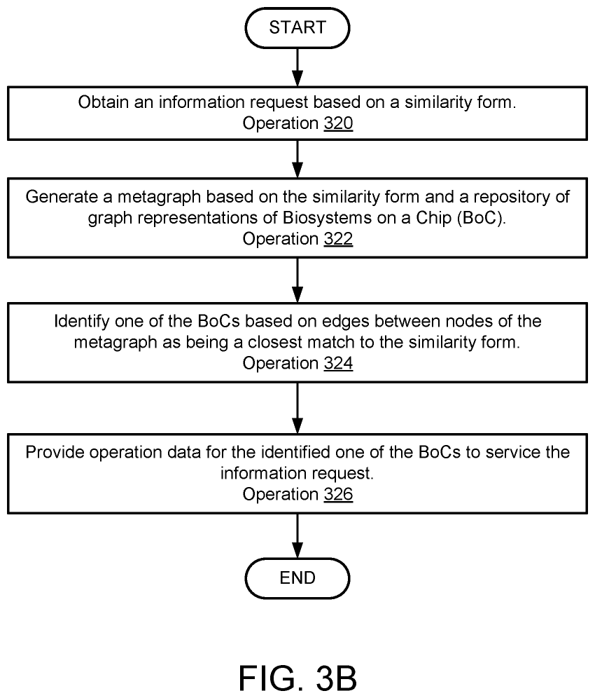

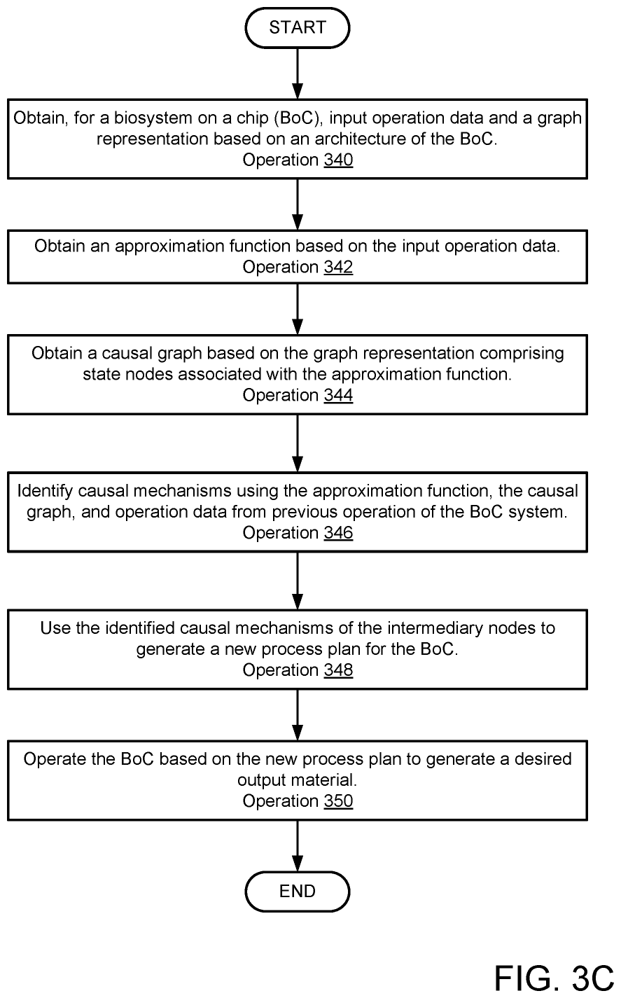

When performing their functionality, one or more of data management system 100 and BoC deployment 110 may perform all, or a portion, of the methods and/or actions shown in FIGS. 3A-3C.

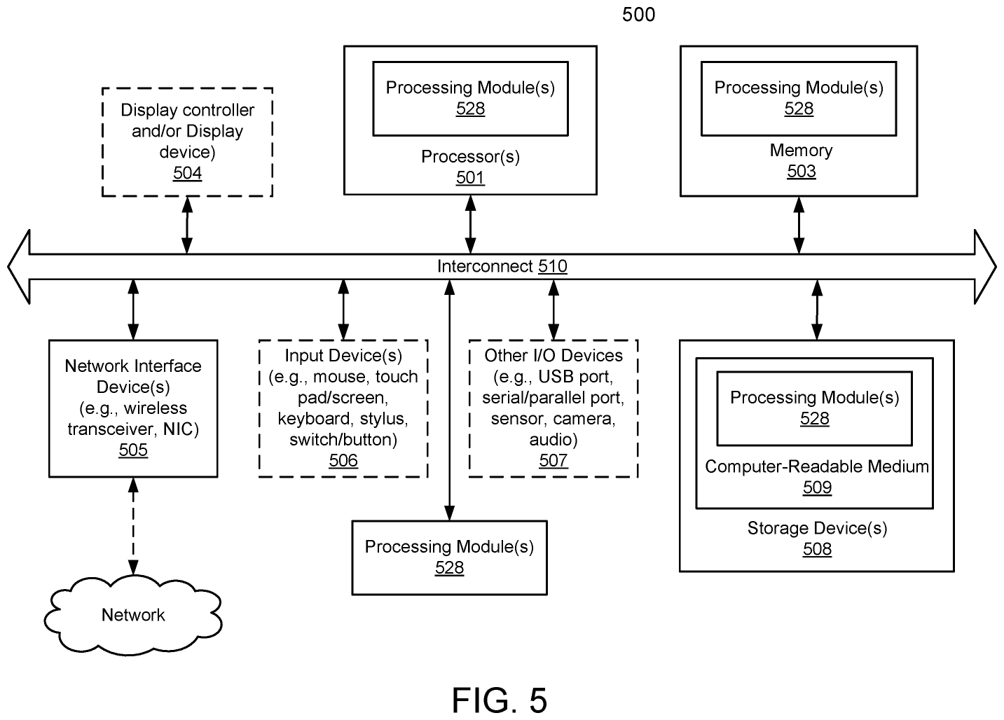

Any of data management system 100 and BoC deployment 110 may be implemented using a computing device (e.g., a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

In an embodiment, data management system 100 is implemented with multiple computing devices. For example, some of the computing devices may provide data storage services while other computing devices may provide services related to identifying similarities and/or differences of various BoC based systems.

Any of the components illustrated in FIG. 1A may be operably connected to each other (and/or components not illustrated) with a communication system (e.g., 105).

In an embodiment, communication system 105 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1A as including a limited number of specific components, a system in accordance with an embodiment may include fewer, additional, and/or different components than those illustrated therein.

Turning to FIG. 1B, a diagram of an example instance of BoC deployment 110 in accordance with an embodiment is shown. As discussed above BoC deployment 110 may implement a process to generate one or more output materials, such as output material 160. Output material 160 may be a desired product such as, for example, a protein or another type of material.

To generate output materials, BoC deployment 110 may include BoC 116. In FIG. 1B, a top view of BoC 116 is shown. BoC 116 may include a body in which any number of chambers (e.g., 120A-120B), channels (e.g., 122A-122E), and/or other types of features (not shown) are positioned. These chambers and channels may facilitate, for example, completion of chemical reactions that may transform one or more input materials (e.g., 150A-150C) into one or more output materials (e.g., 160).

A chamber may be a cavity or other space within the body of BoC 116. For example, BoC 116 may be implemented by starting with a block of material (e.g., a sheet) and removing some of the material to form chambers. A cover or other structure may be positioned to close the top portions of the chambers. While shown in FIG. 1B as including two chambers 120A, 120B, a BoC in accordance with an embodiment may include any number of chambers without departing from embodiments disclosed herein. The chambers may be of similar and/or different shapes/sizes.

A channel may be a cavity or other space within the body of BoC 116 that connects chambers to other chambers, input or output ports, and/or other structures. For example, BoC 116 may be implemented by starting with a block of material (e.g., a sheet) and removing some of the material to form the channels. A cover or other structure may be positioned to close the top portions of the channels. While shown in FIG. 1B as including five channels 122A-122E, a BoC in accordance with an embodiment may include any number of channels without departing from embodiments disclosed herein. The channels may be of similar and/or different shapes/sizes, and may connect similar or different other portions of BoC 116.

To manage the processes performed with BoC 116, control system components 112 of BoC deployment may include any number of actuators (e.g., 130A-130D). The actuators may manage flow of materials through BoC 116. For example, the actuators may include valves, pumps, and/or other types of flow control components, which may be computerized thereby allowing for computer control of the flow of materials through BoC 116. While not shown in FIG. 1B, control system components 112 may include other types of components such as, for example, heating elements, cooling elements, and/or other types of devices that may manage flows of material and/or environmental conditions presented to the materials.

Control system components 112 may also include any number of robotic controllers (e.g., 132A). A robotic controller may be a computer controllable machine that may modify the operation of BoC 116 and/or components (e.g., such as changing out any of input materials 150A-150C). The computer controllable machine may be implemented with, for example, a mechanical arm, pinching appendages to pick up items, and/or other features. The operation of control system components 112 may be managed via algorithms performed by local computing resources 170 and/or remote computing resources.

To manage the processes performed with BoC 116, sensors 114 of BoC deployment 110 may include any number of sensors (140A-140E, others shown in FIG. 1B are not numbered for readability). These sensors may obtain data regarding the process performed with BoC 116 such as, for example, flowrates of materials, temperatures/pressures of materials at various locations in BoC 116, and/or other characteristics of the process performed with BoC 116.

Any of sensors 114 and control system components 112 may be positioned with (e.g., integrated) or outside of BoC 116. For example, some of these components may be integrated into BoC 116 while other may be positioned outside of BoC 116.

As seen in FIG. 1B, control data for control system components 112 and sensor measurements from sensors 114 may be obtained during operation of BoC 116. This information (e.g., “operation data”) may be stored for future use in a manner that facilitates its future. As will be discussed below, a combination of graph representations and databases may be used to store the operation data and facilitate use of the operation data.

Turning to FIGS. 2A-2E, data flow and data structure diagrams in accordance with an embodiment are shown.

FIG. 2A shows a data flow diagram in accordance with an embodiment. Operation data 202 may be generated during operation of a BoC, and structure data 203 may include information regarding the architecture (e.g., channels, chambers, other features) of the BoC that performed the process through which operation data 202 was obtained. To manage and use operation data 202 in the future, operation data 202 and structure data 203 may be used to store the various portions of operation data 202 in a manner that facilitates ease of use in the future while managing cost for storing the portions.

To do so, operation data 202 may be subjected to database processing 204 to generate database entries 206 in which portions of operation data 202 may be stored. For example, the portions may correspond to sensor measurements (e.g., over the duration of the process) and/or control data (e.g., actions to be performed during operation of a BoC) used to operate actuators and/or other components. Once generated, database entries 206 may be added to operation data database 212.

Generally, operation data database 212 may be implemented with a low computational overhead architecture such as, for example, an unstructured database. For example, the database entries 206 may simply be stored without generating significant metadata and/or other types of indexing data. By doing so, the operation may be efficiently stored, but may limit search functionality (e.g., due to limited metadata) for operation data database 212.

To facilitate searching of operation data 202 and/or comparison between the BoC and other BoCs, operation data 202, structure data 203, and/or database entries 206 may be subjected to graph processing 208. Graph processing may generate a graph representation and/or updates to an existing graph representation (e.g., 210) of the structure (e.g., architecture) of the BoC. For example, graph representation 214 may include nodes corresponding to chambers and channels of the BoC, and the edges between the nodes may correspond to connections (e.g., 124) between these portions of the BoC.

Additionally, each of the nodes may be associated with pointers to the database entries 206 that include operation data associated with the corresponding component of BoC. In this manner, to identify operation data associated with a particular component of a BoC, the corresponding node (e.g., which may include a label or other association indicator) may be identified in the graph representations. The associated pointers for the identified node may identify the entries of operation data database 212 in which the operation data is stored.

Turning to FIG. 2B, a data structure diagram in accordance with an embodiment is shown. In FIG. 2B, a portion of graph representation 214A corresponding to a chamber and three channels of a BoC is shown. Node 220 may correspond to the chamber while the other nodes 222-226 may correspond to the channels. Edges 230, 232, 234 between the nodes indicate the fluidic connections between these structures of the BoC. Thus, in this example, edges 230-234 indicate that each of the channels connects to the chamber associated with node 220.

Node 220 may also include or have associated with it any number of pointers that point to operation data of operation data database 212 associated with the chamber. In this example, node 220 is associated with two pointers that point to (e.g., identify) two entry 212A-212B of operation data database 212. These entries include measurements of pressure and temperature of the fluids within the chamber during operation of the BoC.

In an embodiment, the operation data for each component is stored as part of information for a corresponding node (e.g., part of the graph representation).

While shown in FIG. 2B with a limited number of nodes, pointers, and edges, it will be understood that these data structures may include any number of these components without departing from embodiments disclosed herein.

Turning to FIG. 2C, a data flow diagram in accordance with an embodiment is shown. Once the data structures illustrated in FIG. 2B are obtained, the data structures may be used to facilitate use of BoC system data. To do so, for example, a user interested in identifying similar BoC systems may submit a similarity form 240. The similarity form may define a hypothetical architecture of BoC system (e.g., which may be based on an existing or new BoC), including the numbers and arrangements of chambers, channels, and/or other features of the hypothetical BoC system.

Once submitted, similarity form 240 may be subjected to graph processing 242, which may also use any number of graph representations of BoC systems as input. The graph representations of the BoC systems may be stored in a repository, such as graph representation repository 246.

The graph processing 242 may generate metagraph 244. Metagraph 244 may be a graph representation of the similarities between the similarity form and the other BoCs.

Metagraph 244 may include any number of nodes corresponding to each of the BoC systems for which graph representations are available, and the similarity form. The edges of the nodes may indicate the level of similarity between the similarity form and the BoCs. For example, larger numbers of edges and/or weights of the edges between two nodes may indicate a higher level of similarity between the nodes. Thus, to identify a BoC most similar to similarity form 240, the numbers of edges and/or weights of the edges between the node of metagraph 244 corresponding to the similarity form and each other node. The other node connected to the node corresponding to the similarity form by the largest number of edges may be the most closely related, architecturally to similarity form 240.

Additionally, in an embodiment, different edges may represent the similarity of different characteristics (e.g., indicated by the weights of the corresponding edges) of two graph representations and corresponding architectures of BoCs. For example, a first edge may represent a similarity between the quantity of nodes in two graph representations, and a second edge may represent a similarity between the average number of edges between the nodes in the two graph representations. For highly dissimilar characteristics, edges may not even be added to further convey the differences in architectures of BoCs. By doing so, metagraph 244 may be filterable based on the type of similarity a user may wish to investigate. For example, in FIG. 2D, if a user wished to investigate similarity levels of numbers of nodes, all of the first edges 260 associated with other characteristics may be removed to provide a visual indication with respect to the level of similarity between the number of nodes of the similarity form and the graph representation of the first BoC. The weight of the remaining edge (e.g., thickness) may convey the level of similarity regarding that specific characteristic of the architectures of the similarity form and the first BoC.

Turning to FIG. 2D, a data structure diagram in accordance with an embodiment is shown. In FIG. 2D, an example of metagraph 244 is shown for a similarity form and two BoCs.

As seen in FIG. 2D, metagraph 244 may include three nodes 250, 252, 254. Node 250 may correspond to the similarity form, while the other nodes 252, 254 may correspond to two different BoCs having different architectures.

First edges 260 between node 250 and node 252 may indicate a level of similarity between the architecture specified by the similarity form and the first BoC. Second edges 262 between node 250 and node 254 may indicate a level of similarity between the architecture specified by the similarity form and the second BoC.

As seen in FIG. 2D, in this example, first edges 260 may include two edges and second edges 262 may include three edges. Thus, in this example, it may be concluded that second BoC is more similar to the similarity form than the first BoC.

However, while illustrated in this example with multiple edges representing similarity, as noted above, weights of the edges may be used (in conjunction with and/or alternatively to multiple edges) to represent the level of similarity and/or similarity levels with respect to certain characteristics of the architectures of multiple BoCs. For example, any two nodes may be connected with a single edge that has a weight (e.g., graphically this could be a thickness of a line representing the edge in a depiction of metagraph 244, and may represent an overall similarity) and/or multiple edges that may represent the similarity of different characteristics of two BoC architectures.

The edges between the nodes may be identified through pattern matching, graph analysis, inferencing, and/or other means. For example, the architecture specified by the similarity form may be transformed into (or used as a basis for) a graph representation and compared to the graph representation of the architecture of the first BoC and the second BoC. Similar node and edge patterns in each graph representation may give rise to edges between the corresponding nodes of metagraph 244 (and/or increased weights of edges). The edges of metagraph 244 may be added when, for example, a graph representation of a similarity form and a graph representation of a BoC include a same node with a same edge pattern about the node. Thus, in an embodiment, the number of edges that may be present between nodes of metagraph 244 may be up to the number of nodes of the similarity form.

Turning to FIG. 2E, a data flow diagram in accordance with an embodiment is shown. In FIG. 2E, data management system 100 may process previous data from BoC system operations to facilitate refinement of subsequent BoC system operations. Specifically, data management system 100 may perform processes to identify one or more causal mechanism 285 with respect to a BoC system. Causal mechanism 285 may provide insight into the reasons for which a BoC operated in a particular manner, and how different BoCs with different or similar architectures are likely to operate in the future.

To do so, data management system 100 may obtain input operation data 270 which may be based on control data used to manage a previous operation of a BoC system. Data management system 100 may obtain graph representation 214 for the BoC system. Both of these data structures may be read from the data structures obtained via the flows illustrated in FIGS. 2A-2C. For example, input operation data 270 may be obtained from operation data 202 which was stored in the database as part of the previously completed BoC system operation.

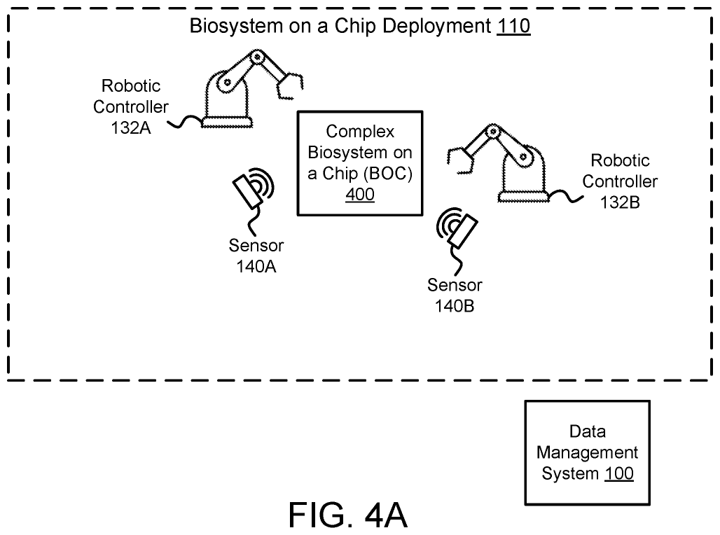

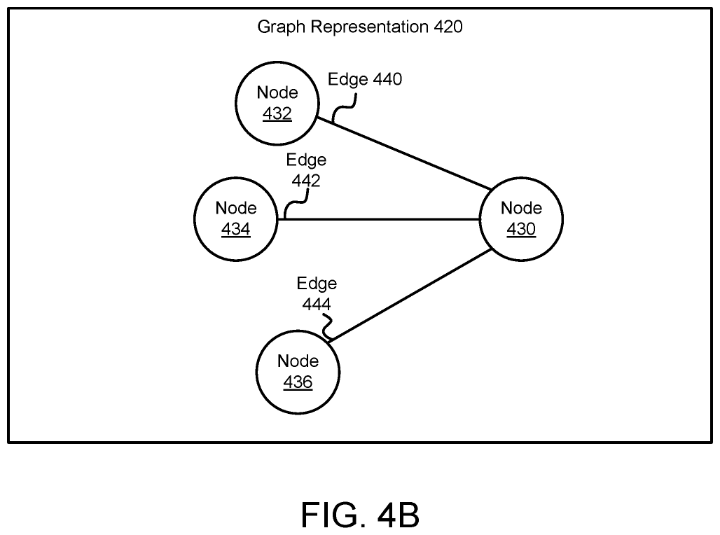

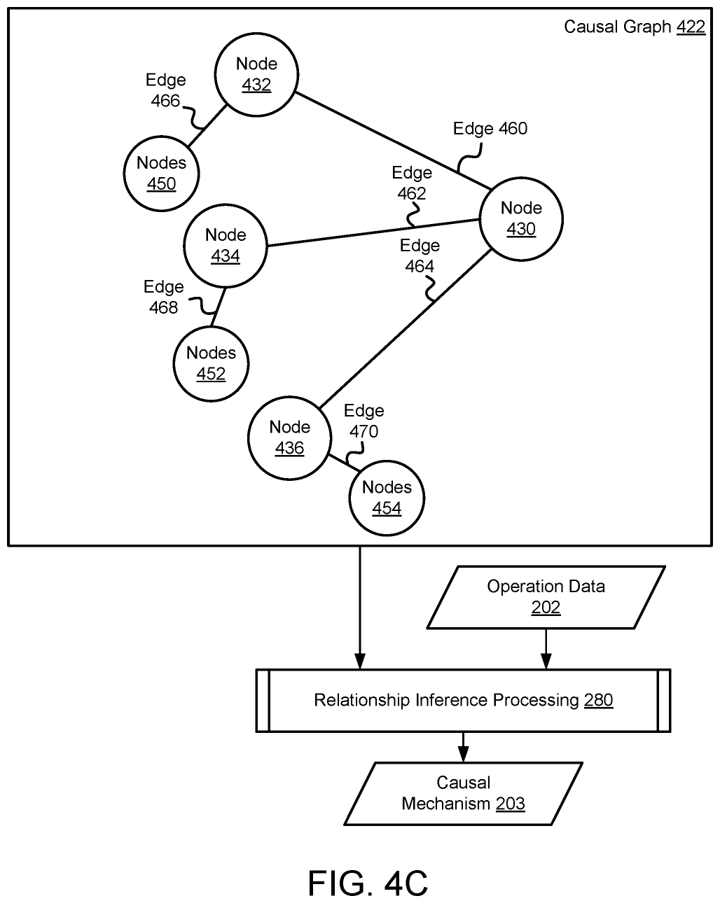

Once obtained, input operation data 270 may be subjected to function approximation processing 272 to obtain an approximation function 274 for input operation data 270. Approximation function 274 may represent the result of the control data being used in the previous operation. For example, approximation function 274 may indicate rates at which materials are ingested into the inputs of a BoC for different types of control data (e.g., if a control data says set pump speed at 1 milliliters/minute, the approximation function may specify the per unit time rate of material input into the BoC). As will be discussed with respect to FIGS. 4A-4C, the approximation function may be used to stimulate causal graph 278 to identify causal mechanism 285.

Similarly, graph representation 214 may be subjected to causal graph processing 276 to obtain causal graph 278. Causal graph 278 may be a graph database with nodes based on the nodes and edges of graph representation 214. Refer to FIGS. 4A-4C for additional details regarding causal graph 278.

To obtain causal graph 278, causal graph processing 276 may transform the causal graph by modifying the graph structure. The graph structure may be modified by (i) using causal graph 278 as a template (e.g., by making a copy of it), (ii) transforming edges in the template to edges that represent one or more causal mechanisms (e.g., states of the related nodes such as a level of fluid connectivity between two existing components that cause changes to states of other nodes), and (iii) adding other nodes reflecting input and/or output of the BoC. Approximation function 274 may be used to convert control data for a previous run into input usable to drive the operation of causal graph 278.

Once obtained, approximation function 274 and causal graph 278 may be used to perform relationship inference processing 280 to obtain one or more of causal mechanism 285. Causal mechanism 285 may, as noted above, indicate a cause and effect relationship with respect to a BoC. For example, one possible cause and effect relationship may be that the flow rate of material through a channel connected to a chamber may be proportional to the pressure in the chamber of the BoC.

To identify these relationships, approximation function 274 may be used. A portion of operation data 202 (e.g., sensor data) associated with the nodes may also be used to derive initial causal relationships for the edges positioned between the nodes of causal graph 278. Other portions of operation data 202 may then be used to test and refine the initial causal relationships (e.g., to test them by, e.g., through running through additional control data presented as input by approximation function 274) until final causal relationships are established and that are consistent with operation data 202. One or more of the final causal relationships may then be causal mechanism 285.

Once obtained, causal mechanism 285 may be used to refine plans for subsequent operations of the BoC, create new plans for operations of other BoCs, and/or design other BoCs. For example, causal mechanism 285 may indicate changes that may be made to modify the operation of a BoC architecture.

These modifications may be implemented automatically (e.g., through automated refinement of plans as various operations of a BoC are performed) and/or in cooperation with a subject matter expert. In an automated scenario, a machine learning model may be used and may take causal mechanism 285 as input and provide, as output, a refined plan for operating a BoC and/or new or modified BoC architecture.

When new plans for operating a BoC are obtained, the plans may be automatically performed thereby forming a closed loop through which operation of a BoC is designed to meet one or more goals.

Any of the processing described with respect to FIGS. 2A-2E may be implemented via one or more applications hosted by one or more computing devices. Any of the data structures (e.g., 270, 214, many others) shown in these figures may be implemented using any number and type of data structures including, for example, tables, lists, databases, graph database, linked lists, and/or other types of data structures.

As discussed above, the components of FIG. 1A may perform various methods to manage and facilitate use of BoC systems. FIGS. 3A-3C illustrate methods that may be performed by the components of FIG. 1A. In the diagrams discussed below and shown in FIGS. 3A-3C, any of the operations may be repeated, performed in different orders, and/or performed in parallel with or in a partially overlapping in time manner with other operations.

Turning to FIG. 3A, a flow diagram illustrating a method of storing and using BoC data in accordance with an embodiment is shown. The method may be performed by a data management system or a data processing system.

At operation 300, operation data for a BoC is obtained. The operation data may be obtained by (i) receiving it form a BoC deployment, (ii) reading it from storage, and/or (iii) receiving it from another device. The operation data may reflect operation of the BoC.

At operation 302, the operation data is stored in a database. The operation data may be stored in the database by generating and adding entries to the database. The entries may include and/or be based on the operation data such that the operation data may be retrieved from the database. The data may not include, for example, indications of how or from where the operation data was obtained. Rather, the database may be an unstructured database.

At operation 304, a graph update is generated based on the stored operation data. The graph update may be generated by (i) generating a new graph representation for the BoC if none existed previously, and (ii) generating a change log for an existing graph representation of the BoC that updates nodes corresponding to the components of the BoC associated with various portions of the operation data. For example, pointers may be added to the nodes (or may otherwise be associated with the nodes). The pointers associated with each node may facilitate retrieval of the operation data from the data that is associated with component of the BoC associated with the node.

At operation 306, a graph representation of the BoC is updated using the graph update. The graph representation may be updated by either (i) using the new graph representation as the updated graph representation of the BoC in a case in which no graph representation of the BoC previously existed and/or (ii) applying the update change log to the existing graph representation of the BoC.

At operation 308, a request for operation data for a component of the BoC is obtained. The request may be obtained by (i) receiving it from another device, (ii) receiving it from an application, and/or (iii) obtaining user input that indicates the request. The component may be, for example, a chamber, channel, and/or other portion of the BoC.

At operation 310, a node of the graph representation of the BoC is identified based on the component. For example, an identifier of the component may be used to search the graph representation to identify the node (e.g., which may be labeled with the identifier of the component).

At operation 312, a pointer associated with the identified node is used to read the operation data for the component from the database. The pointer may be used by performing a read or lookup using the information included in the pointer. For example, the pointer may specify entries of the database. The specified entries may be read from the database, and the operation may be in the read entries of the database.

The method may end following operation 312.

Using the method illustrated in FIG. 3A, embodiments disclosed herein may facilitate storage and use of operation data from BoCs.

Turning to FIG. 3B, a flow diagram illustrating a method of using stored operation data in accordance with an embodiment is shown. The method may be performed by a data management system or a data processing system.

At operation 320, an information request based on a similarity form is obtained. The information request may specify, for example, that a type of operation data for a BoC most similar to the similarity form be provided.

At operation 322, a metagraph is generated based on the similarity form and a repository of graph representations of BoC systems. The metagraph may be generated by generating a graph representation for the architecture indicated by the similarity form. The graph representation of the similarity forms and the graph representations in the repository may be used to establish nodes (e.g., one per graph representation) of the metagraph. Edges of the metagraph may be established based on similarity between the graph representation for the similarity form and the other graph representations in the repository. Thus, the node corresponding to the graph representation of the similarity form may be connected to the other nodes of the metagraph by numbers of edges corresponding to a level of similarity between the architecture specified by the similarity form and the architectures of the BoC systems.

At operation 324, one of the BoCs is identified based on edges between the nodes of the metagraph as being a closest match to the similarity form. The one of the BoCs may be identified by counter the edges between the node corresponding to the similarity form and the other nodes. The BoC associated with the other node that is connected to the node corresponding to the similarity form with the largest number of edges may be the identified one of the BoCs.

At operation 326, operation data for the identified one of the BoCs is provided to service the information request. The operation data may be provided by identified the graph representation corresponding to the BoC, identifying one or more nodes of the identified graph representation relevant to the requested operation data, identifying pointers associated with the one or more identified nodes, and reading entries of the database using the pointers. The read entries may include the operation data.

The method may end following operation 326.

Using the method illustrated in FIG. 3B, embodiments disclosed herein may facilitate identification and use of operation data for BoCs that are similar to a target BoC architecture. By doing so, the operation data for BoCs may not need to be identified to ascertain its relevance with respect to a desired BoC architecture.

Turning to FIG. 3C, a flow diagram illustrating a method of operating a BoC in accordance with an embodiment is shown. The method may be performed by a data management system or a data processing system.

At operation 340, input operation data and a graph representation for a BoC are obtained. The graph representation may be based on the BoC architecture.

The input operation data may be control data used during a previous process performed with the BoC. The input operation data may be read from a database in which control data, sensor data, and/or other types of data associated with the previous process may be stored.

The graph representation may be read from a repository of graph representations of BoCs, including the BoC.

At operation 342, an approximation function based on the input operation data is obtained. The approximation function may specify input to the BoC as a function of the operation data. Consequently, the approximation function may be used to stimulate a causal graph as part of identifying one or more causal mechanisms.

The approximation function may be any type of function and may, for example, have a linear functional form. For example, the linear functional form, for three nodes a-c, be a*x\hat{ }2+b*x+c where x reflects time steps from the control data used during the previous operation.

At operation 344, a causal graph based on the graph representation is obtained. The causal graph may include (i) a first portion of nodes associated with the approximation function, (ii) a second portion of nodes associated with the structural components of BoC (e.g., and may be based on the nodes of the graph representation of the BoC), and (iii) edges between the second portion of the nodes associated with causal mechanisms.

The causal graph may be obtained by using the graph representation as a template, transforming the edges of the template to reflect causal mechanisms rather than fluid connectivity as the edges may represent in the graph representation, and adding nodes to support the approximation function. The added nodes may be associated with nodes of the template that are associated with features of the architecture of the BoC. For example, each node of the template associated with a feature of the BoC architecture may also be associated with one or more nodes used to support the approximation function. Each of the nodes associated with architecture features may be associated with any number of the added nodes. In contrast to the nodes associated with the architecture features, the added nodes may not be connected to other nodes by edges defining causal mechanisms. Rather, the added nodes may be associated with corresponding nodes. Refer to FIGS. 4A-4C for additional details regarding a causal graph.

At operation 346, causal mechanisms are identified using the approximation function, the causal graph, and operation data from previous operation of the BoC system. The causal mechanisms may be identified by using the approximation function to stimulate the causal graph and identify initial causal relationships. For example, the approximation function may provide a set of features T, that is less than a number of time steps from the control data (e.g., the previously performed operation).

The approximation function may then be used to additionally stimulate the causal graph (e.g., by injecting additional functional approximations into the state nodes) to test/refine the initial causal mechanisms associated with the edges to obtain final causal mechanisms. Final causal mechanisms may have a level of predictive power and/or correlation that exceeds a predetermined threshold. Thus, for causal mechanisms that are initially identified but have low predictive power, the causal mechanisms may be discarded and not finalized.

In an embodiment, the causal mechanisms are identified by performing an optimization procedure. The optimization procedure may include, for example, global optimization using an objective function that provides a highest value when the causal mechanism for each edge is consistent for the operation data. The optimization procedure may identify the forms of the causal mechanisms that are the most consistent with the operation data.

At operation 348, the identified causal mechanism is used to generate a new process plan for the BoC. The new process plan may include one or more actions that are different from a process plan used during the previous operation.

The new process plan may be obtained through automated and/or subject matter expert based refinement. For example, the process plan used during the previous operation may automatically be refined using the causal mechanism to avoid an undesired part of the process such as a pressure level within a chamber exceeding a threshold (e.g., a rated pressure level of the BoC).

At operation 350, the BoC is operated based on the new process plan to generate a desired output material. The BoC may be operated using control data in accordance with the new process plan. The control data may cause actuators and/or other components to operate differently than as they operated during the previous operation. Consequently, undesired operation of the BoC during the previous operation of the BoC may be less likely to recur during this subsequent operation of the BoC in accordance with the new process plan.

For example, the new process plan may reduce pumping rates of material into the BoC, which may reduce pressure in a pressure sensitive cavity of the BoC.

The method may end following operation 350.

Using the method illustrated in FIG. 3C, embodiments disclosed herein may facilitate refinement of processes performed with BoC systems by identifying causal mechanisms. Likewise, BoC architectures and/or new operations may also benefit through identification of causal mechanisms.

Additionally, the causal mechanisms identified may facilitate insight into the operation of BoC systems usable for research purposes. For example, the causal mechanisms may provide researchers with information regarding why certain processes occurred in a BoC during an operation. In contrast, the operation data in its raw form may merely document what occurred and may not explicitly indicate what the certain occurrences happened during operation of a BoC. A researcher or other type of subject matter expert (which may be a person or an automated system, such as an automated design system) may use the identified causal mechanism to improve BoC based systems.

Turning to FIGS. 4A-4B, diagrams illustrating a process of operating a BoC in accordance with an embodiment are shown.

Turning to FIG. 4A, a diagram showing a BoC system in accordance with an embodiment id shown. Consider a scenario in which complex BoC 400 will be used to perform a process for generating a desired material. To prepare to manage the process, data management system 100 may investigate the architecture of complex BoC 400 and/or may use operation data from previously performed processes to identify likely causal mechanisms at play in complex BoC 400.

For example, during a first operation of complex BoC 400, various robotic controllers 132A-132B may perform processes for input material into complex BoC 400 that cause a pressure within a chamber of complex BoC 400 and measured by sensors 140A-140B to reach levels that may result in damage to complex BoC 400.

However, due to the architecture of complex BoC 400, it may not be apparent why the pressure in the chamber reached such high levels during the operation. For example, complex BoC 400 may include three channels in fluid communication with the chamber. To avoid risk of damage associated with this process, data management system 100 may automatically attempt to identify a causal mechanism that lead to this high level of pressure and refine a plan for subsequent operation of BoC deployment 110 to reduce high level of pressure.

Turning to FIG. 4B, a graph representation 420 of complex BoC 400 in accordance with an embodiment is shown. Graph representation 420 may be generated using the methods described with respect to FIGS. 4A-4B.

Graph representation 420 may include node 430 (associated with the chamber) and nodes 432, 434, 436 (associated with the channels). Edges 440-444 may indicate that the channels are in fluid communication with the chamber.

To generate a causal graph for complex BoC 400, graph representation 420 may be used as a template. Turning to FIG. 4C, a diagram of causal graph 422 in accordance with an embodiment is shown.

As seen causal graph 422 may include the same nodes as those in graph representation 420, which may be used as a template. Groups of nodes 450-456 may be inserted and associated with nodes 430-436. Each of the groups of nodes may include a node corresponding to each term of the approximation function.

The edges of the template may be transformed to represent causal mechanisms, and edges between the added nodes and the existing nodes may be added to reflect the additional causal mechanisms. For example, edges 460-464 (which may be based on the edges of the graph representation of the BoC architecture) between nodes 430-436 and edges 466-470 interconnecting the new and added nodes may represent the causal mechanisms.

Edge 460 may, for example, represent the causal mechanism that causes the pressure in the chamber to be proportional to the flow rate through the channel associated with node 432.

To identify the causal mechanisms associated with edges 460-470, the added nodes 462-466 may be stimulated using the approximation function. For example, control data used during the previous operation of complex BoC 400 may be used to identify flow rates into nodes 432, 434, 436. The corresponding operation data (e.g., sensor measurements) may then be used to identify initial causal mechanisms associated with edges 460-470. For example, functional relationships between the data associated with the nodes connected to each of the edges may be identified.

For example, if a flow rate associated with node 432 is 1 milliliter per minute and a pressure associated with node 430 is 1 pascal, then an initial relationship of 1 pascal per 1 milliliter per minute may be identified. The rest of the operation data may be used to test and refine the initial causal mechanism to obtain a final causal mechanism. Initial and/or refined causal mechanisms that are consistent across a predetermined range of the operation data may be designated as final causal mechanisms. This process may be performed as part of relationship inference processing 280 through which causal mechanism 285 is obtained.

In this manner, a causal relationship between different processes may be established. Consequently, the causal relationship may then be used to refine the plan for operation of complex BoC 400.

For example, consider a scenario where an inverse causal relationship between flow rate through a channel associated with node 434 and pressure in the chamber is established. Using this causal relationship, the new operation plan may increase the flow rate through the channel by using the control data associated with node 464 as a template, and modifying the template to increase the flow rate to the channel.

Thus, as illustrated in FIGS. 4A-4C, embodiments disclosed herein may provide a system that facilitates continuous process refinement and updating through identification and use of causal mechanisms in BoC based systems.

Any of the components illustrated in FIGS. 1-4C may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include 10 devices such as devices (e.g., 505, 506, 507, 508) including network interface device(s) 505, optional input device(s) 506, and other optional 10 device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an image processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a biosystem on a chip (BoC) deployment, the method comprising:
obtaining:
input operation data for a previously performed operation with the BoC deployment, and
a graph representation based on an architecture of a BoC of the BoC deployment;
obtaining an approximation function based on the input operation data;
obtaining a causal graph based on the graph representation, the causal graph comprising a first portion of nodes associated with the approximation function, a second portion of nodes corresponding to nodes of the graph representation, and edges between the second portion of the nodes representing causal mechanisms for components of the architecture of the BoC;
identifying the causal mechanisms for the components of the architecture of the BoC using the approximation function and operation data from the previously performed operation with the BoC deployment, the operation data comprising sensor data indicating characteristics of the components of the architecture of the BoC during the previously performed operation;
obtaining a new process plan for the BoC using the identified causal mechanisms, the new process plan being different from a previous process plan used during the previously performed operation; and
performing a new operation with the BoC deployment based on the new process plan to generate a desired output material.

2. The method of claim 1, wherein obtaining the causal graph comprises:
using the graph representation as a template, the template comprising first nodes corresponding to architectural features of the BoC with edges between the first nodes indicating fluid connectivity between the architectural features;
defining edges of the template to represent the causal mechanisms; and
adding the first portion of the nodes to the template to obtain the causal graph.

3. The method of claim 2, wherein the features of the architecture comprise:
a chamber positioned in a body of the BoC; and
a channel positioned with the chamber and adapted to place the chamber in fluid communication with another feature of the architecture.

4. The method of claim 3, wherein the identified causal mechanisms indicate causal relationships that are likely to be true during performance of the new operation of the BoC deployment.

5. The method of claim 4, wherein a causal relationship of the causal relationships indicates a functional relationship between a fluid pressure in the chamber and a fluid flow rate through the channel.

6. The method of claim 1, wherein the input operation data comprises control data used to orchestrate performance of the previously performed operation with the BoC deployment, the control data defining actions performed by active components of the BoC deployment during the previously performed operation.

7. The method of claim 1, wherein the graph representation comprises architectural element nodes with edges that indicate fluid connectivity between elements of the architecture of the BoC corresponding to the architectural element nodes, and each of the architectural elements nodes being associated with database entries of a database.

8. The method of claim 7, wherein the database entries associated with each of the architectural element nodes comprise related sensor measurements, the architectural elements nodes facilitating identification of all related sensor measurements during the previously performed operation.

9. The method of claim 8, wherein the database is an unstructured database.

10. The method of claim 1, wherein the BoC deployment takes, as input, an input material and through performance of the new operation generates the desired output material.

11. A non-transitory machine-readable medium having instructions stored therein, which when executed by a processor, cause the processor to perform operations for managing operation of a biosystem on a chip (BoC) deployment, the operations comprising:
obtaining:
input operation data for a previously performed operation with the BoC deployment, and
a graph representation based on an architecture of a BoC of the BoC deployment;
obtaining an approximation function based on the input operation data;
obtaining a causal graph based on the graph representation, the causal graph comprising a first portion of nodes associated with the approximation function, a second portion of nodes corresponding to nodes of the graph representation, and edges between the second portion of the nodes representing causal mechanisms for components of the architecture of the BoC;
identifying the causal mechanisms for the components of the architecture of the BoC using the approximation function and operation data from the previously performed operation with the BoC deployment, the operation data comprising sensor data indicating characteristics of the components of the architecture of the BoC during the previously performed operation;
obtaining a new process plan for the BoC using the identified causal mechanisms, the new process plan being different from a previous process plan used during the previously performed operation; and
performing a new operation with the BoC deployment based on the new process plan to generate a desired output material.

12. The non-transitory machine-readable medium of claim 11, wherein obtaining the causal graph comprises:
using the graph representation as a template, the template comprising first nodes corresponding to architectural features of the BoC with edges between the first nodes indicating fluid connectivity between the architectural features;
transforming the edges of the template into the second portion of the nodes; and
adding the first portion of the nodes to the template to obtain the causal graph.

13. The non-transitory machine-readable medium of claim 12, wherein the features of the architecture comprise:
a chamber positioned in a body of the BoC; and
a channel positioned with the chamber and adapted to place the chamber in fluid communication with another feature of the architecture.

14. The non-transitory machine-readable medium of claim 13, wherein the identified causal mechanisms indicate causal relationships that are likely to be true during performance of the new operation of the BoC deployment.

15. The non-transitory machine-readable medium of claim 14, wherein a causal relationship of the causal relationships indicates a functional relationship between a fluid pressure in the chamber and a fluid flow rate through the channel.

16. A data processing system, comprising:
a processor; and
a memory coupled to the processor to store instructions, which when executed by the processor, cause the processor to perform operations for managing operation of a biosystem on a chip (BoC) deployment, the operations comprising:
obtaining:
input operation data for a previously performed operation with the BoC deployment, and
a graph representation based on an architecture of a BoC of the BoC deployment;
obtaining an approximation function based on the input operation data;
obtaining a causal graph based on the graph representation, the causal graph comprising a first portion of nodes associated with the approximation function, a second portion of nodes corresponding to nodes of the graph representation, and edges between the second portion of the nodes representing causal mechanisms for components of the architecture of the BoC;
identifying the causal mechanisms for the components of the architecture of the BoC using the approximation function and operation data from the previously performed operation with the BoC deployment, the operation data comprising sensor data indicating characteristics of the components of the architecture of the BoC during the previously performed operation;
obtaining a new process plan for the BoC using the identified causal mechanisms, the new process plan being different from a previous process plan used during the previously performed operation; and
performing a new operation with the BoC deployment based on the new process plan to generate a desired output material.

17. The data processing system of claim 16, wherein obtaining the causal graph comprises:
using the graph representation as a template, the template comprising first nodes corresponding to architectural features of the BoC with edges between the first nodes indicating fluid connectivity between the architectural features;
transforming the edges of the template into the second portion of the nodes; and
adding the first portion of the nodes to the template to obtain the causal graph.

18. The data processing system of claim 17, wherein the features of the architecture comprise:
a chamber positioned in a body of the BoC; and
a channel positioned with the chamber and adapted to place the chamber in fluid communication with another feature of the architecture.

19. The data processing system of claim 18, wherein the identified causal mechanisms indicate causal relationships that are likely to be true during performance of the new operation of the BoC deployment.

20. The data processing system of claim 19, wherein a causal relationship of the causal relationships indicates a functional relationship between a fluid pressure in the chamber and a fluid flow rate through the channel.
